(19) United States
(12) Patent Application Publication
(10) Pub. No.: US 2017/0295296 A1
(43) Pub. Date: Oct. 12, 2017

(54) IMAGE SCANNING SYSTEM

(71) Applicant: Microtrek International Inc., Hsinchu (TW)

(72) Inventor: Kuo-Huei YU, Hsinchu (TW)

(21) Appl. No.: 15/484,462

(22) Filed: Apr. 11, 2017

(30) Foreign Application Priority Data
Apr. 12, 2016 (TW) 105205094

(51) Int. Cl. H04N 1/40; H04N 1/193; H04N 1/00

(52) U.S. Cl. CPC H04N 1/40056; H04N 1/00018; H04N 1/193

(57) ABSTRACT

An image scanning system for scanning an object is disclosed. The image scanning system includes a light source, an optical lens, an image capturing unit and a light barrier element. The light source irradiates an object to produce an image light, and the optical lens converges the image light. The image capturing unit is disposed at a light leaving side of the optical lens, and the image capturing unit captures the image light to form an image. The light barrier element is disposed at a light entering side of the optical lens or disposed between the optical lens and the image capturing unit, and the light barrier element selectively allows the image light within a predetermined range of an incident angle to pass through.

### BACKGROUND OF THE INVENTION

### 1. Field of the Invention

The present invention relates to an image scanning system, and more particularly to an image scanning system for enhancing the image quality.

### 2. Description of the Prior Art

In the traditional image scanning system, for an optical lens, the image light having a larger incident angle is more prone to generate the phenomenon of image distortion or other adverse optical response, and affects the optical imaging quality thereof. In order to provide a finer image quality, the traditional image scanning system usually needs to be added many complex optical components, so the cost is expensive and a compact design can not be achieved.

To sum up the foregoing descriptions, how to provide an image scanning system for enhancing the image quality is the most important goal for now.

### SUMMARY OF THE INVENTION

The present invention provides an image scanning system, which uses a light barrier element to limit the image light having a large incident angle, so as to enhance the image quality.

An image scanning system of one embodiment of the present invention is used for scanning an object. The image scanning system includes a light source, an optical lens, an image capturing unit and a light barrier element. The light source irradiates an object to produce an image light, and the optical lens converges the image light. The image capturing unit is disposed at a light leaving side of the optical lens, and the image capturing unit captures the image light to form an image. The light barrier element is disposed at a light entering side of the optical lens or disposed between the optical lens and the image capturing unit, and the light barrier element selectively allows the image light within a predetermined range of an incident angle to pass through.

The objective, technologies, features and advantages of the present invention will become apparent from the following description in conjunction with the accompanying drawings wherein certain embodiments of the present invention are set forth by way of illustration and example.

### BRIEF DESCRIPTION OF THE DRAWINGS

FIG. 1 is a schematic view showing an image scanning system of one embodiment of the present invention.

FIG. 2 is a schematic view showing a side view of a light barrier element of one embodiment of the present invention.

FIG. 3 is a schematic view showing an image scanning system of another embodiment of the present invention.

### DESCRIPTION OF THE PREFERRED EMBODIMENT

Various embodiments of the present invention will be described in detail below and illustrated in conjunction with the accompanying drawings. In addition to these detailed descriptions, the present invention can be widely implemented in other embodiments, and apparent alternations, modifications and equivalent changes of any mentioned embodiments are all included within the scope of the present invention and based on the scope of the Claims. In the descriptions of the specification, in order to make readers have a more complete understanding about the present invention, many specific details are provided; however, the present invention may be implemented without parts of or all the specific details. In addition, the well-known steps or elements are not described in detail, in order to avoid unnecessary limitations to the present invention. Same or similar elements in Figures will be indicated by same or similar reference numbers. It is noted that the Figures are schematic and may not represent the actual size or number of the elements. For clearness of the Figures, some details may not be fully depicted.

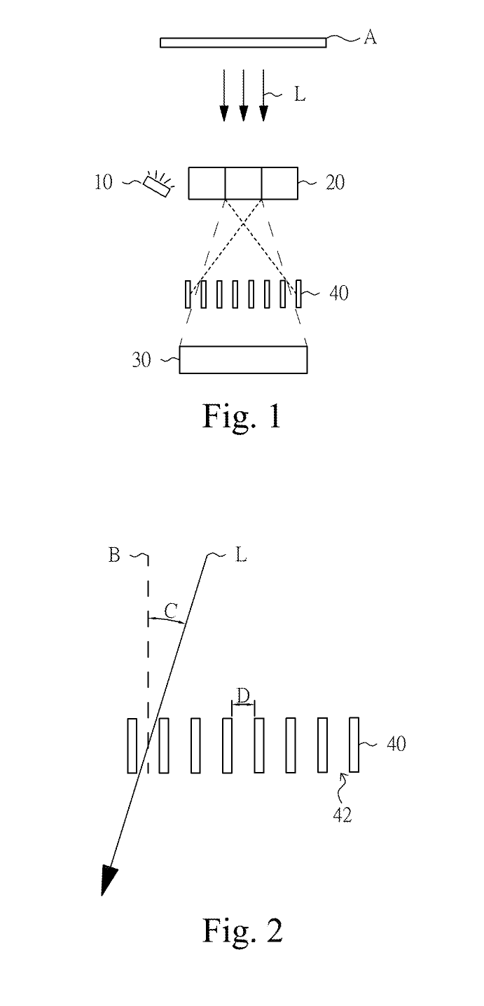

Referring to FIG. 1, an image scanning system of one embodiment of the present invention is used for scanning an object A. The image scanning system includes a light source 10, an optical lens 20, an image capturing unit 30 and a light barrier element 40. The light source 10 irradiates the object to produce an image light L. For example, the light source 10 includes a fluorescent lamp, a light-emitting diode, or a fluorescent excitation light source, but is not limited to this. The optical lens 20 converges the image light L to the image capturing unit 30. For example, the optical lens 20 includes a convex lens, but is not limited to this. In one embodiment, the optical lens 20 is a rod lens array having multiple rod lenses, and has a better imaging quality. The image capturing unit 30 is disposed at a light leaving side of the optical lens 20, and the image capturing unit 30 captures the image light L to form an image. In one embodiment, the image capturing system uses a contact image sensor (CIS) like structure, which, only small rod lenses needed, distance to the to-be-scanned object A may be closer, such that a light path of the image light L may be shortened significantly, and a layout space that the optical design needs may be reduced, so as to realize a compact image scanning system.

It should be noted that, for an average optical system, the image light having a larger incident angle is more prone to generate the phenomenon of image distortion and color offset, and affects the image profile and color accuracy. Referring to FIG. 1 and FIG. 2 together, in order to enhance the image quality, one embodiment of the present invention provides a light barrier element 40 disposed at a light entering side of the optical lens 20 or disposed between the optical lens 20 and the image capturing unit 30 (i.e., the light leaving side of the optical lens 20), and the light barrier element 40 selectively allows the image light L within a predetermined range of an incident angle C to pass through. In one embodiment, the predetermined range of the incident angle C is less than or equal to 30 degrees, so as to block the image light L having a larger incident angle.

Referring to FIG. 2, in one embodiment, the light barrier element 40 comprises multiple light channels 42, and the multiple light channels 42 are parallel to an optical axis B of the optical lens. It is noted that an inner diameter D of the multiple light channels 42 must be less than a diameter of the optical lens, so as to effectively block the image light L having a larger incident angle. In another embodiment, the inner diameter D of the light channel 42 is between 1 and 100 microns. In yet another embodiment, if the optical lens is a rod lens array having multiple rod lenses, then the inner diameter D of the light channel 42 must be less than a diameter of the rod lens as well, and those skilled in the art may transform to use. In yet one embodiment, a thickness of the light barrier element 40 is between 0.1 and 1 mm, and the light barrier element 40 itself belongs to a macroscopic-scale optical element.

It may be understood that the present invention uses a macroscopic-scale, micron-scale light barrier which is different from a microcosmic-scale, nanometer-scale grating. The light barrier element uses the linearity of the geometric optics to block the incident light having a too large incident angle. On the other hand, the grating element is designed to have a periodic space arrangement that cooperates with the wavelength scale of the wavelength of the incident light (e.g., from 300 nanometers to 800 nanometers for the visible light), such that the amplitude or the phase or both of the incident light is modulated by the periodic space, so as to change the optical parameters of the transmission light or the reflected light. Thus, the structural scale and the technical principle of the light barrier element and the grating element are totally different.

Continued with the foregoing descriptions, the light barrier element of the present invention may achieve the effect of blocking the incident light having a too large incident angle, even though it may not have a structure of a periodic space arrangement. In one embodiment, the light barrier element comprises multiple tube bodies or multiple parallel baffles. For example, in a case that a light barrier element is composed of multiple parallel, juxtaposed baffles, even though the thickness of each baffle may not be constant which causes the spacing of the multiple juxtaposed baffles not to be periodic, then the light barrier element formed by multiple irregularly-arranged baffles may still achieve the effect of blocking the incident light having a too large incident angle, as long as the spacing between each baffle (i.e., the inner diameter of the light channel) is the same, e.g., the spacing between each baffle is 50 microns, and the predetermined range of the incident angle of each light channel is within 30 degrees.

In one embodiment, the light barrier element is disposed between the optical lens and the image capturing unit, such that no other blocking thing exists between the object (or a platform bearing the object) and the optical lens, and the Object space is kept empty. As a result, the space of the image scanning system may be saved, so as to realize a compact image scanning system.

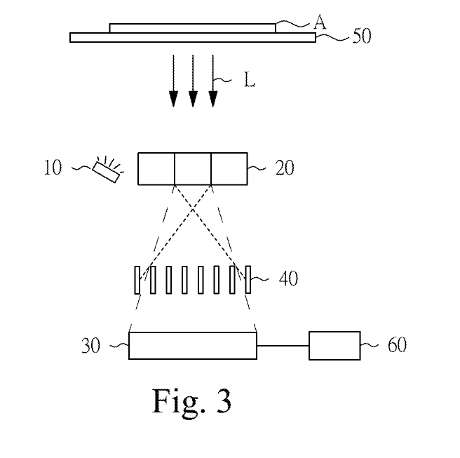

Referring to FIG. 3, in one embodiment, the image scanning system further includes a platform 50. The platform includes a transparent material, wherein the object A is disposed on the platform 50 and is irradiated by the light source 10 to produce the image light L. In one embodiment, the image scanning system further includes a driving unit 60. The driving unit 60 is connected with the image capturing unit 30, and the driving unit 60 drives the image capturing unit 30 to scan the object A. For example, the driving unit 60 further includes a link assembly (not shown) connected with the image capturing unit 30. Preferably, the light source 10 and optical lens 20 may be connected with the link assembly, and may cooperate with the image capturing unit 30 (e.g., a contact image sensor) to scan the object A synchronously, so as to obtain a scanned image having a higher brightness and a high contrast. Also, for example, the driving unit 60 may be connected with the platform 50, and the driving unit 60 may drive the platform 50 to move the object A, such that the object A may be moved with respect to the image capturing unit 30. Not limited to this, modifications and alternations may be made by those skilled in the art.

To sum up the foregoing descriptions, the image scanning system of the present invention uses a light barrier element to limit the image light having a large incident angle and improve the phenomenon of image distortion and color offset, so as to enhance the image quality. In addition, a combination of the light barrier element having a simple structure, the small rod lenses, and the contact image sensor may reduce the layout space that the optical design needs, so as to realize a compact image scanning system.

What is claimed is:

1. An image scanning system for scanning an object, comprising:
a light source for irradiating an object to produce an image light;
an optical lens for converging the image light;
an image capturing unit disposed at a light leaving side of the optical lens to capture the image light to form an image; and
a light barrier element disposed at a light entering side of the optical lens or disposed between the optical lens and the image capturing unit to selectively allow the image light within a predetermined range of an incident angle to pass through.

2. The image scanning system according to claim 1, wherein the light barrier element is disposed between the optical lens and the image capturing unit.

3. The image scanning system according to claim 1, wherein the light barrier element comprises multiple light channels, and the multiple light channels are parallel to an optical axis of the optical lens.

4. The image scanning system according to claim 3, wherein an inner diameter of the multiple light channels is less than a diameter of the optical lens.

5. The image scanning system according to claim 3, wherein an inner diameter of the light channel is between 1 and 100 microns.

6. The image scanning system according to claim 3, wherein the optical lens comprises multiple rod lenses.

7. The image scanning system according to claim 6, wherein an inner diameter of the multiple light channels is less than a diameter of the rod lens.

8. The image scanning system according to claim 1, wherein the light barrier element comprises multiple tube bodies or multiple parallel baffles.

9. The image scanning system according to claim 1, wherein the predetermined range of the incident angle is less than or equal to 30 degrees.

10. The image scanning system according to claim 1, wherein a thickness of the light barrier element is between 0.1 and 1 mm.

11. The image scanning system according to claim 1, further comprising:
a platform comprising a transparent material, wherein the object is disposed on the platform.

12. The image scanning system according to claim 1, further comprising:
a driving unit for driving the image capturing unit and the object to move with respect to each other to scan the object.
